(19) United States
(12) Patent Application Publication
(10) Pub. No.: US 2018/0121906 A1
(43) Pub. Date: May 3, 2018

(54) TRANSACTION CASE

(71) Applicant: Joseph B. Browand, Henderson, NV (US)

(72) Inventor: Joseph B. Browand, Henderson, NV (US)

(21) Appl. No.: 15/337,968

(22) Filed: Oct. 28, 2016

(51) Int. Cl. G06Q 20/34; G06Q 20/42; A45C 11/00; A45C 11/18; A45C 13/00; H02J 7/00; H04B 1/3888

(52) U.S. Cl. CPC G06Q 20/353; G06Q 20/42; A45C 11/00; A45C 11/182; A45C 13/001; H02J 7/0045; H04B 1/3888; A45C 2011/002; A45C 13/005

(57) ABSTRACT

A transaction case performs multiple functions related for protecting a communication device and consolidating transaction data from at least one specific payment card onto a universal payment card. A housing receives the communication device. A compartment stores items. A cover opens and closes over the compartment with a lock having a wallet for holding items. A payment card slot holds universal payment cards. The universal payment card uses the transaction data from the specific payment card to perform transactions. The universal payment card utilizes security features selectively moving the universal payment card in position to perform transactions. An electromagnet connects to a spring-loaded lever controlling movement of the universal payment card. A secret code must be input to generate a signal for interfering with the magnetic field, such that the universal payment card to be released from the slot for use. A power source powers the case.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A housing aperture ion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to a transaction case that protects and retains a communication device and a payment card. More particularly, the invention relates to a transaction case that forms a protective cover for a communication device, stores personal items, and enables transactions with a self-contained universal payment card that selectively moves in and out from the case while using transaction data from at least one specific payment card.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that cellular phone accessories are an integral part of modern communications. The accessories may include any hardware or software that is not integral to the operation of a mobile phone as designed by the manufacturer.

Typically, one such accessory is a phone case. The phone case is generally lightweight, rubber, and sized to securely receive a phone while enabling access to the display screen of a smart phone. The phone case provides a water resistant, shock resistant, and drop resistant cases for mobile devices, such as smart phones. The phone case provides apertures that enable passage of data cables for communicating with the phone contained within.

It is known that a credit card is a payment card issued to users as a system of payment. It allows the cardholder to pay for goods and services based on the holder's promise to pay for them. The issuer of the card creates a revolving account and grants a line of credit to the consumer from which the user can borrow money for payment to a merchant or as a cash advance to the user.

In many instances, the communication features of the smart phone can be incorporated with the transaction functionality of the credit card. This is especially useful for shopping online, or performing long distance transactions.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a perspective view of an exemplary transaction casing, in accordance with an embodiment of the present invention;

FIG. 2 illustrates a perspective view of an exemplary transaction case receiving an exemplary communication device having an exemplary software application, in accordance with an embodiment of the present invention;

FIG. 3 illustrates a perspective view of an exemplary at least one charging cable and an exemplary key, in accordance with an embodiment of the present invention;

FIGS. 4A and 4B illustrate views of an exemplary housing forming a connectivity with the charging cable, where FIG. 4A illustrates a frontal view, and FIG. 4B illustrates a top angle perspective view, in accordance with an embodiment of the present invention;

FIGS. 5A and 5B illustrate views of an exemplary cover moving between an open and closed positon over an exemplary compartment, where FIG. 5A illustrates an open position, and FIG. 5B illustrates a closed position, in accordance with an embodiment of the present invention;

FIGS. 6A, 6B, and 6C illustrate views of an exemplary lever and electromagnet cover moving an exemplary universal payment card between a storage position and an operational position, where FIG. 6A illustrates the storage position, and FIG. 6B illustrates the universal payment card moving into an operational position, and FIG. 6C illustrates the universal payment card in the operational positon, in accordance with an embodiment of the present invention;

FIG. 7 illustrates an exemplary data transfer device receiving transaction data from an exemplary specific card, in accordance with an embodiment of the present invention;

FIGS. 8A and 8B illustrate screen shot views of at least one specific payment card viewable on the communication device, where FIG. 8A illustrates multiple specific cards for selection from a software application on the communication device, and FIG. 8B illustrates a pending transaction with the specific payment card through use of the universal payment card, in accordance with an embodiment of the present invention; and

FIG. 9 illustrates a block diagram depicting an exemplary client/server system which may be used by an exemplary web-enabled/networked embodiment, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight housing aperture of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight housing aperture on the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware--for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of” and “consisting essentially of” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred, or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The present invention will now be described in detail with reference to embodiments thereof as illustrated in the accompanying drawings.

There are various types of devices that encase and protect a communication device and facilitate use of a payment card that may be provided by preferred embodiments of the present invention. In one embodiment of the present invention, a transaction case is configured to perform multiple functions related to protecting a communication device and consolidating transaction data from at least one specific payment card onto a universal payment card. The universal payment card may then use the transaction data from the specific payment card to perform transactions. The universal payment card also utilizes security features that selectively moves the universal payment card in position to perform transactions. A secret code must be input to generate a signal for enabling the universal payment card to be exposed for use.

In some embodiments, the case may include a housing that receives a communication device. The housing may be configured to form a protective cover over the communication device, such as a smart phone. The housing is also configured with at least one compartment for storing personal items, such as payment cards, money, keys, business cards, and the like. The compartment may utilize a lockable and hidden cover to inhibit tampering and theft. The cover may be hinged so as to pivot onto the compartment. A software that uses a secret code may be used to open the compartment. However, if the power source for the case is depleted, a key may be used to lock and unlock the cover from the compartment.

The cover may have a payment card slot that receives a universal payment card. A wallet slot may also be used to receive and store items, such as money, business cards, and at least one specific payment card. The payment card slot and the wallet slot are two different slots. The universal payment card is operable to perform transactions while extended and held directly from the payment card slot in the housing. This is possible because the universal payment card pivotally extends from the payment card slot into an operational position, and retracts into the payment card slot into a storage position.

A lever connects the universal payment card with the housing for controlling pivotal movement of the universal payment card in and out of the slot. The lever selectively moves the universal payment card in and out of the slot. An electromagnet regulates the lever by controllably generating a magnetic field. The magnetic field is generated to regulate the pivoting motion of the universal payment card.

In some embodiments, a code may be input into a software application. The code enables generation of a signal that interferes with the magnetic field. This interference releases the lever, such that the universal payment card is pivotally released out of the slot to perform financial transactions.

In one embodiment, a data transfer device operatively joins the case. The data transfer device works with an integrated software application on the communication device to transfer a transaction data from at least one specific payment card to the universal payment card. Thus, the universal payment card operatively connects with at least one specific payment card that may or may not be contained in the compartment. In this manner, the universal payment card may perform transactions with the transaction data of the specific payment card.

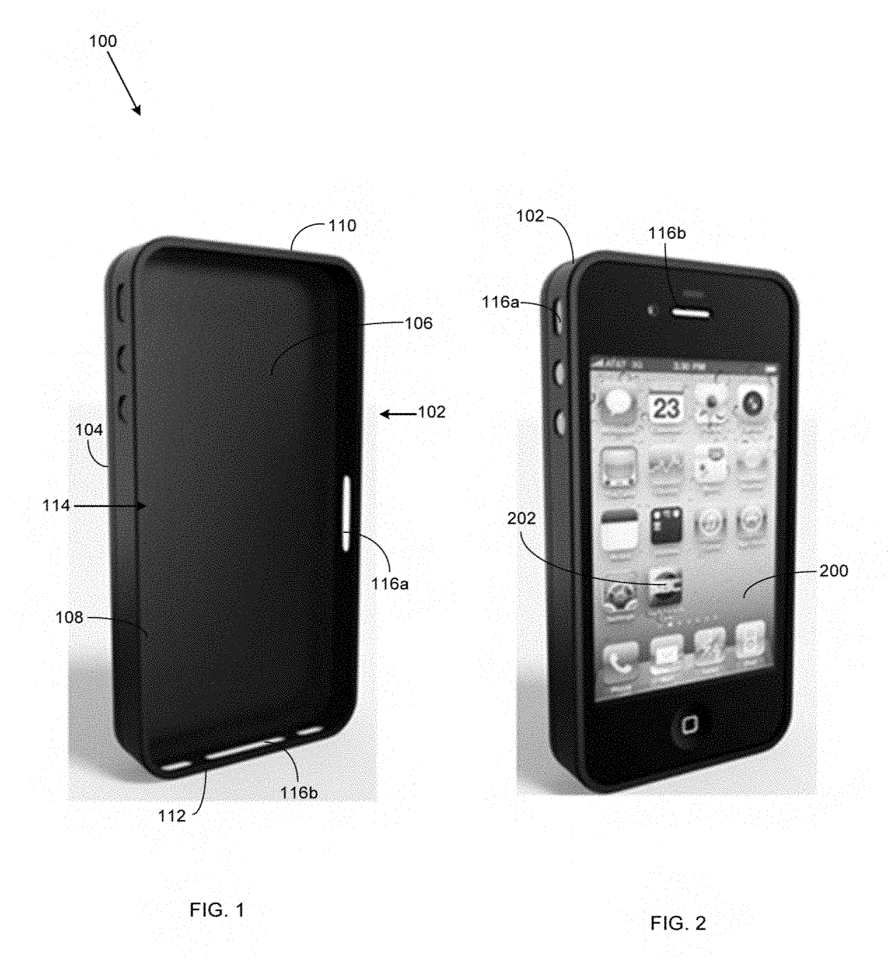

FIG. 1 illustrates a perspective view of an exemplary transaction casing, in accordance with an embodiment of the present invention. In one aspect of the present invention, a transaction case 100 forms a protective cover for a communication device, stores personal items, and enables transactions with a self-contained universal payment card that selectively moves in and out from the case while using transaction data from at least one specific payment card.

In one embodiment, the transaction case may be used to at least partially encase and cover a smartphone or other smart device. The case may include a housing 102. The housing is generally resilient and malleable so as to accept variously sized and dimensioned communication devices. The housing may include an outer surface 104, an inner surface 106, and a flanged edge 108. The flanged edge is configured to fold over onto the communication device for enhanced retention and to inhibit slippage.

In some embodiments, the housing may further include an opening 114, a top end 110, and a bottom end 112. The opening enables visibility and access to a display screen on the communication device. The housing may be configured to protect the communication device against shocks and moisture. The housing can cover communication devices such as smart phones, tablets, laptops, smart watches, and other portable electronic devices.

The edges of the housing may include at least one housing aperture 116a, 116b. The housing aperture may be configured to align with, and enable passage of at least one charging cable. The charging cable power a power source in the housing. The power source may include, without limitation, a battery. Suitable materials for the housing may include, without limitation, rubber, flexible polymer, high-density polyethylene, acrylonitrile butadiene styrene, polyvinyl chloride, polyethylene, stainless steel, aluminum, and aluminum alloy.

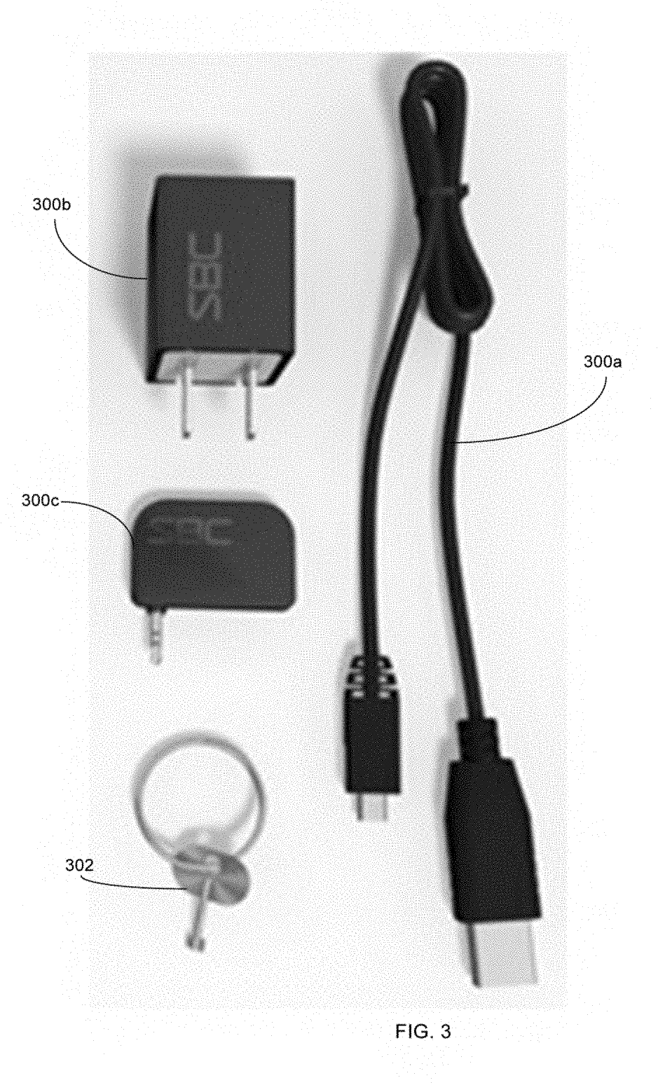

FIG. 2 illustrates a perspective view of an exemplary transaction case receiving an exemplary communication device having an exemplary software application, in accordance with an embodiment of the present invention. In one aspect of the present invention. A charging cable joins with a communication device 200 by passing through the at least one housing aperture. The charging cable may be used to transfer electrical power to the power source, or data to and from the communication device through the housing aperture. The communication device may include, without limitation, a smart phone, a tablet, and a laptop. A software application may be downloadable on the communication device for operation of the case and various payment cards. The software application may be accessible through an icon 202. Thus, in one embodiment, clicking the icon enables access to the software application. The software application is used to lock and unlock the cover through use of a secret code.

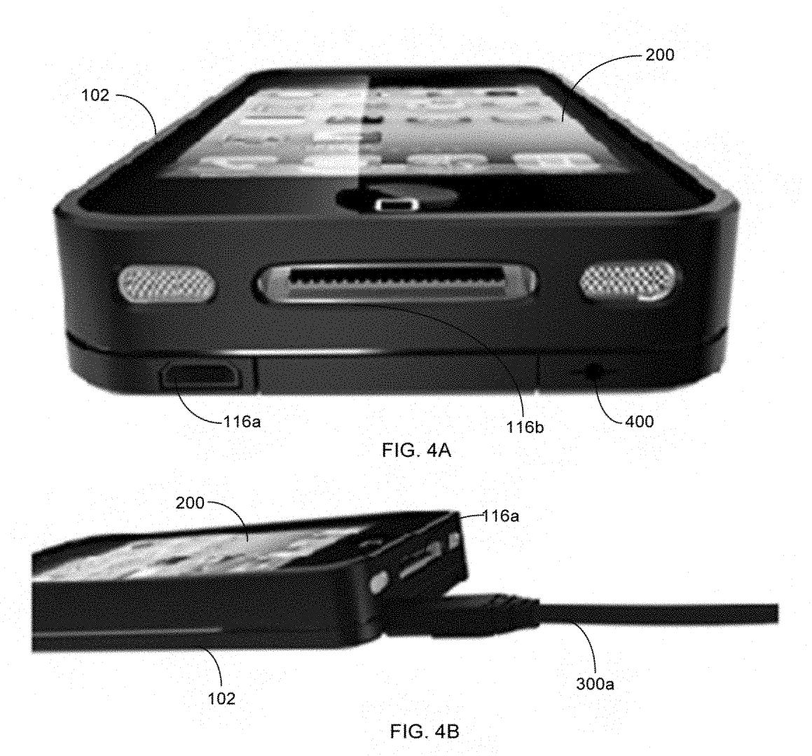

FIG. 3 illustrates a perspective view of an exemplary at least one charging cable and an exemplary key, in accordance with an embodiment of the present invention. In one aspect of the present invention, at least one charging cable 300 works in conjunction with the case and the communication device to enable efficient transfer of electrical power to the power source. In some embodiments, the charging cable may include, without limitation, a USB cable, a dongle, hosted device, speakers, recharging plugs, data storage devices, and the like. In other embodiments, various data cables may also be used to transfer data for communicative and transactional functions. For example, without limitation, a transaction data may be downloaded or swiped onto the universal payment card through the data cable.

In some embodiments, the case may utilize software to unlock and open the cover and access the universal payment card in the payment card slot. In one possible usage, a PIN may be entered in the phone screen, which actuates the clips of the compartment cover to disengage from the holes such that the cover opens. Also, the software may be used to track credit card balances, payment due dates, minimum payments due, etc. The software may also transmit reminders in the form of text messages or messages displayed on the phone's screen about those balances or due dates.

However, as a backup to the software, a key 302 may also be used to unlock a cover over a compartment in the housing. The key is especially effective if the power source expires. The key provides an extra layer of security to protect transaction data and items that may be stored in the compartment. In one exemplary use, the key is inserted into a key axle that unlocks the cover over the compartment incase a power source, such as a battery expires.

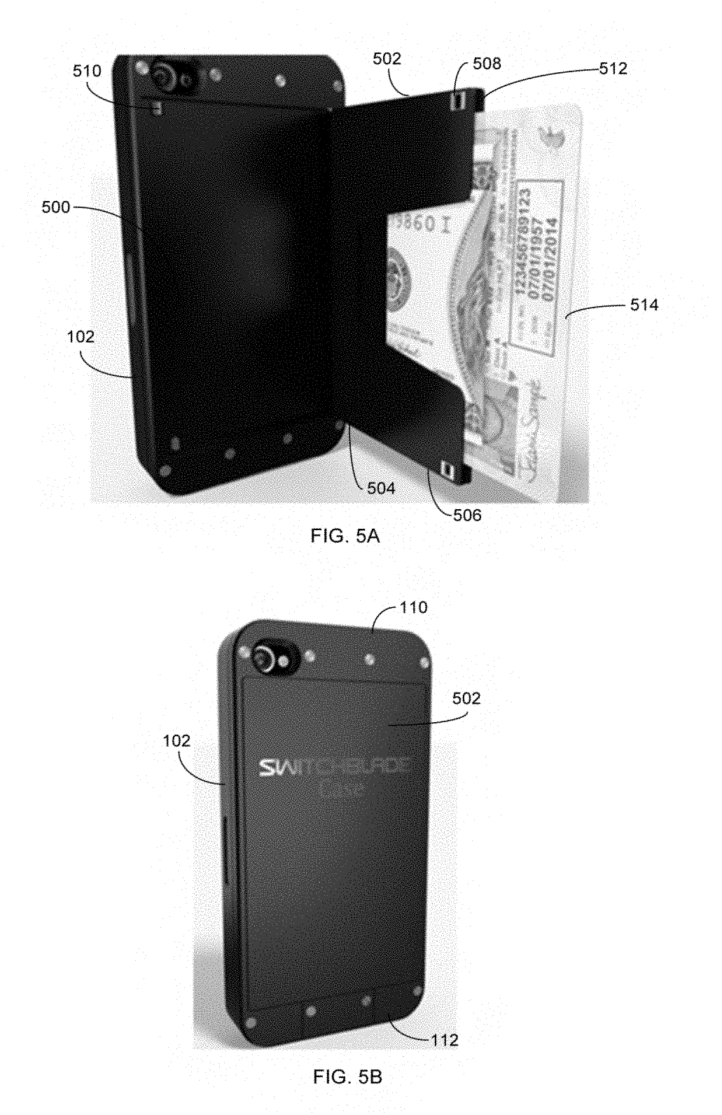

FIGS. 4A and 4B illustrate views of an exemplary housing forming a connectivity with the charging cable, where FIG. 4A illustrates a frontal view, and FIG. 4B illustrates a top angle perspective view, in accordance with an embodiment of the present invention. In one aspect of the present invention, the housing aperture may be sized and dimensioned to receive electrical power through the top end of the housing. The electrical power runs through the charging cable, passing through any section of the housing, including the protective cover. Though, the housing apertures are generally positioned to align with standard communication device data and power ports.

In one possible embodiment, the charging cable is hooking up to the housing to recharge the battery of the case. The housing does have its own power source, such as a battery. It is significant to note that data from a payment card is programed into the software application for use by the universal payment card by sliding the payment card through the dongle. As discussed above, a key axle 400 may be configured to receive the key. The key axle is geared to lock and unlock the cover on the housing. The key provides an extra layer of security to protect transaction data and items that may be stored in the compartment.

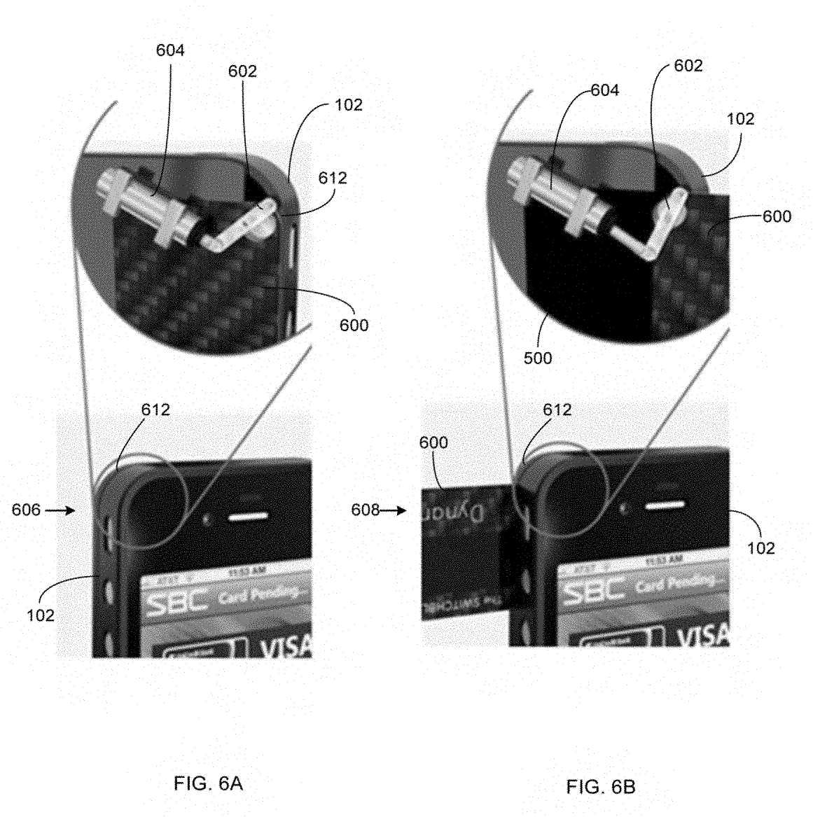

FIGS. 5A and 5B illustrate views of an exemplary cover moving between an open and closed positon over an exemplary compartment, where FIG. 5A illustrates an open position, and FIG. 5B illustrates a closed position, in accordance with an embodiment of the present invention. In one aspect of the present invention, the case may also include at least one compartment 500 for storage of at least one item 514. The compartment may include a cavity that forms in a rear section of the housing, opposite the opening. A lockable cover 502 hingedly connects to the compartment, moving between an open positon and a closed positon to regulate access to the compartment.

In one alternative embodiment, multiple compartments can be used. The compartments can be located on the rear, front, or sides of the housing. In other embodiments, the compartments may slidably pull out from the housing like a drawer.

In one embodiment, the cover may include a hinge end 504 and a lock end 506. The hinge end pivots against a hinge on the edge of the housing. The lock end enables fastenable closure of the cover over the compartment. In one possible embodiment, the lock end may include an aperture 508 that mates with a clip 510 on the edge of the compartment, such that the cover locks into place over the compartment when the aperture and clip are engaged.

In another possible embodiment, a key locks and unlocks the cover. While the key may unlock the cover, the key is a backup in case the power source is expired. However, if the power source of the case is not dead the user may access the software app, then choose a wallet option, enter a secret code. This automatically opens the cover.

In some embodiments, the cover may include a wallet slot 512 that is configured to receive items. The items may include, without limitation, money, ID and other items can be stored in so as to act as a lockable wallet. The wallet slot may hold personal items. The wallet slot is built into the compartment cover. In one embodiment, a PIN is entered in the phones screen and the clips of the cover disengage from the holes such that the cover opens.

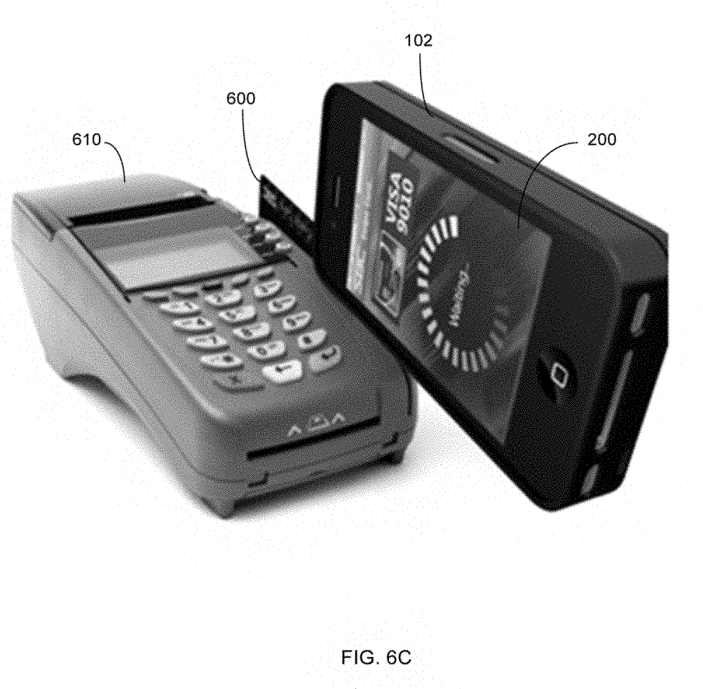

FIGS. 6A and 6B illustrate views of an exemplary lever and electromagnet cover moving an exemplary universal payment card between a storage position and an operational position, where FIG. 6A illustrates the storage position, FIG. 6B illustrates the universal payment card moving into operational position, and FIG. 6C shows the universal payment card in operational positon. In one aspect of the present invention, a universal payment card 600 is housed within a payment card slot 612 that is disposed on one end of the case. The universal payment card may include a credit card, a debit card, and a gift card. The universal payment card may or may not be sized and dimensioned to match a standard credit card. The universal payment card may also not have independent transaction data, but rather, depends on external transaction data to perform transactions.

In some embodiments, the universal payment card stores in the payment card slot until needed for performing a transaction. A lever 602 joins the universal payment card with the case, whereby the lever pivotally carries the universal payment card in and out of the payment card slot. The lever may include, without limitation, a spring-loaded axle. The universal payment card pivots into the payment card slot for storage in a storage position.

The universal payment card, may also pivot out of the payment card slot and orient generally parallel to one side of the housing, for performing financial transactions in an operational position. Thus, the universal payment card moves between a storage position 606 inside the payment card slot, and the universal payment card moving into operational position. FIG. 6C shows the universal payment card in the operational position and being used. For example, in the operational position, the universal payment card is positioned to be swiped through a card reader 610 for transacting purchases.

In some embodiments, an electromagnet 604 controls actuation of the lever. The lever may include a spring-loaded lever that biases the universal payment card towards the storage position. The electromagnet may include, without limitation, a solenoid. The electromagnet provides a security feature to lock the universal payment card in the storage position in the payment card slot until an authorized unlocking mechanism is actuated. In one exemplary embodiment, the lever locks into the storage positon. A generated signal interferes with the magnetic field generated by the electromagnet. The electromagnet is then triggered to release the spring-loaded lever, and the connected universal payment card, to the operational position. Manual methods such as levers and switches could be used for moving the universal payment card in and out of the universal card slot.

In some embodiments, the signal is generated by inputting a code into a software application on the communication device. The code may include a Personal Identification Number (PIN) that must be entered into the software application on the communication device. The PIN may activate a Bluetooth signal. The Bluetooth signal may then actuate the electromagnet, such that the universal payment card pivots out from the slot into the operational position.

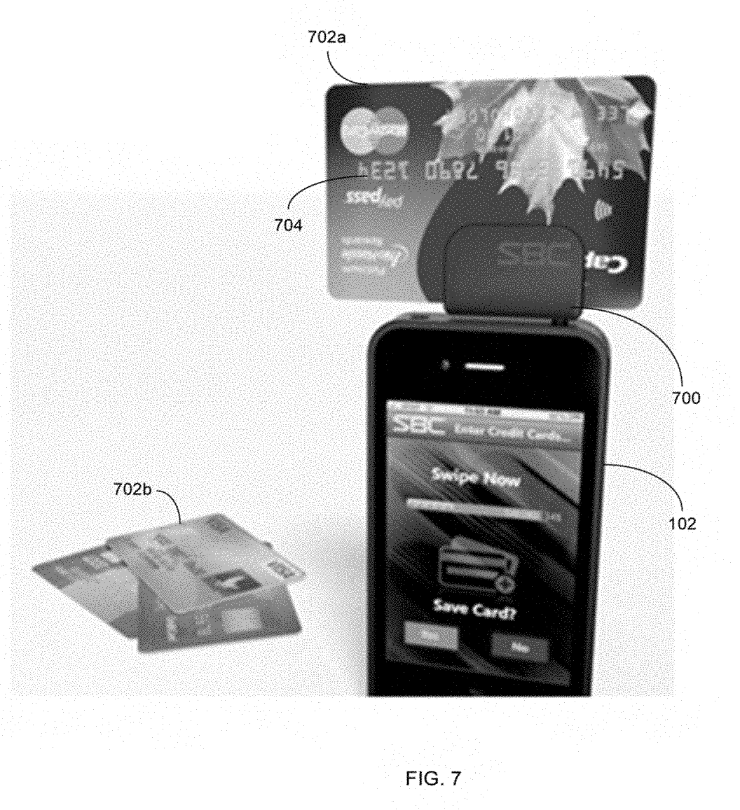

FIG. 7 illustrates an exemplary data transfer device receiving transaction data from an exemplary specific card, in accordance with an embodiment of the present invention. In one aspect of the present invention, a data transfer device 700, such as a dongle, is configured to operatively attach to the communication device through a housing aperture in the housing. The dongle may include a magnetic reader for reading a transaction data 704 from at least one specific payment card 702. A software application enables the transaction data to be stored and viewed on the communication device. Thus, the transaction data is received, stored on the software application, before being transferred to the universal payment card for performing transactions.

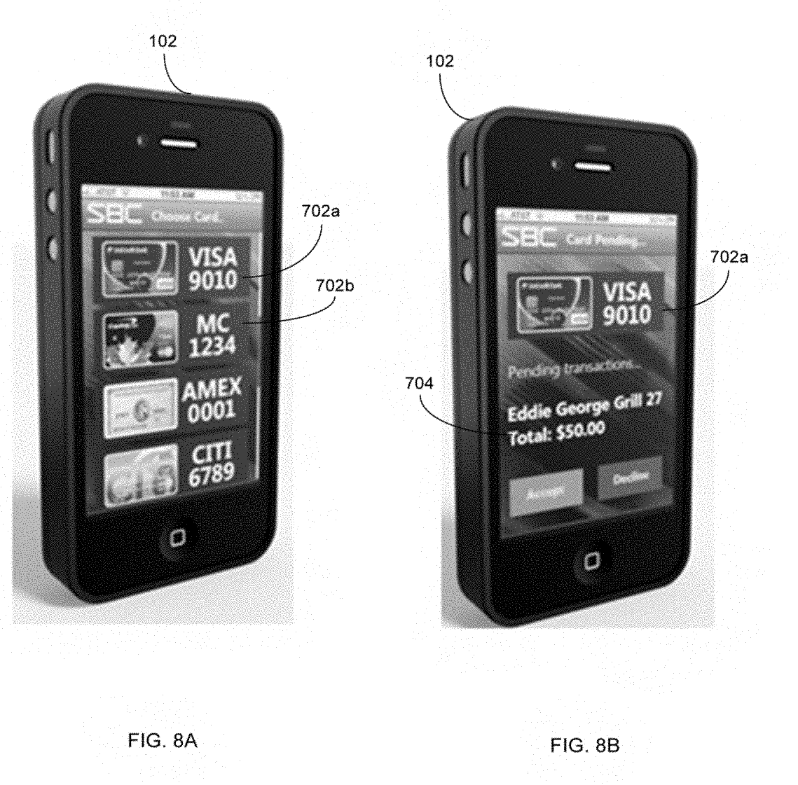

FIGS. 8A and 8B illustrate screen shot views of at least one specific payment card viewable on the communication device, where FIG. 8A illustrates multiple specific cards for selection from a software application on the communication device, and FIG. 8B illustrates a pending transaction with the specific payment card through use of the universal payment card, in accordance with an embodiment of the present invention.

In one aspect of the present invention, the data transfer device integrates a software application for transferring transaction data from at least one specific payment card to the universal payment card. The software may be identified by an icon on the communication device. Thus, selecting the icon enables the specific payment card to be swiped and the corresponding transaction data for that specific card to be saved on the communication device. As shown in FIG. 8A, multiple specific payment cards may simultaneously display on the communication device through the software application.

It is also significant to note that software may also control the universal payment card slot. For example, without limitation, a PIN is entered in the phone screen, which actuates the clips of the compartment cover to disengage from the holes such that the cover opens. Also, the software may be used to track credit card balances, payment due dates, minimum payments due, etc. The software may also transmit reminders in the form of text messages or messages displayed on the phone's screen about those balances or due dates.

Thus, swiping the specific payment card through the magnetic reader in the data transfer device enables transfer of the transaction data to the universal payment card. The transaction data may include, without limitation, a card number, a card expiration, a credit availability, and a maximum transaction amount. FIG. 8B illustrates a specific payment card displaying the transaction data that will transfer to the universal payment card. In this manner, the universal payment card may perform transactions as if it were the specific payment card, e.g., available credit, billing address, automated bill payments, and the like.

In some embodiments, the housing is configured to retain a power source, such as a rechargeable battery, that is dedicated to operating features of the case, not the communication device. For example, the electromagnet or the data transfer device may be powered for operation of the universal payment card.

In one alternative embodiment, both the specific payment card and the universal payment card may be used simultaneously with the same transaction data. In yet another alternative embodiment, the solenoid may power a motor to move the universal payment card, rather than releasing a spring-loaded lever.

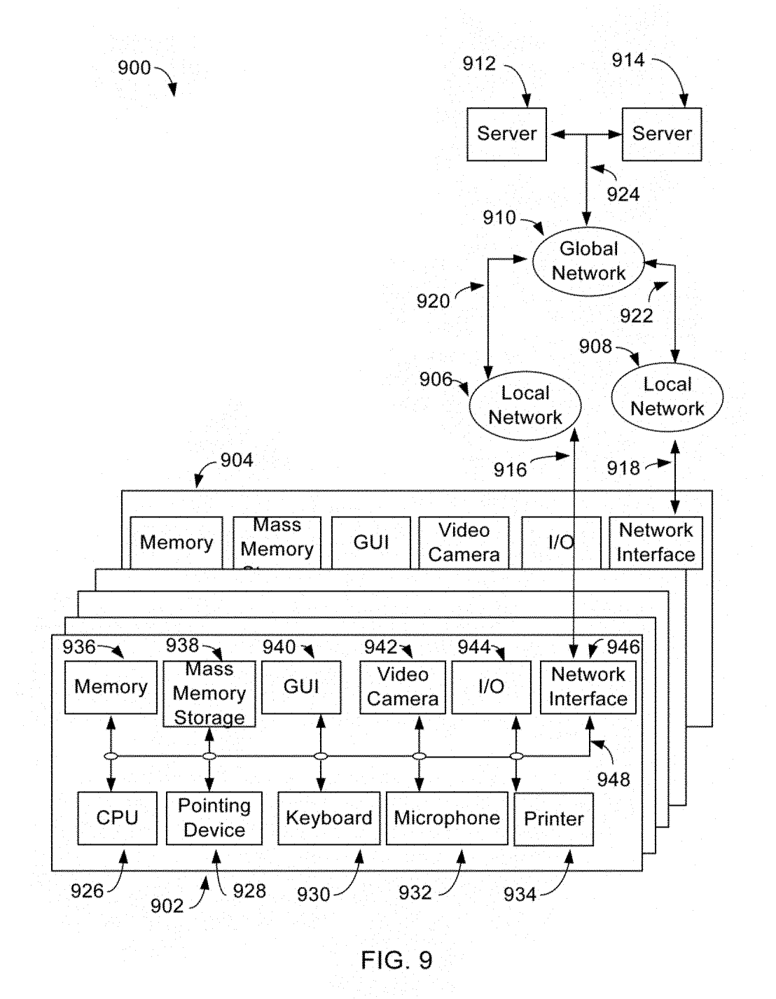

FIG. 9 is a block diagram depicting an exemplary client/server system which may be used by an exemplary web-enabled/networked embodiment of the present invention.

A communication system 900 includes a multiplicity of clients with a sampling of clients denoted as a client 902 and a client 904, a multiplicity of local networks with a sampling of networks denoted as a local network 906 and a local network 908, a global network 910 and a multiplicity of servers with a sampling of servers denoted as a server 912 and a server 914.

Client 902 may communicate bi-directionally with local network 906 via a communication channel 916. Client 904 may communicate bi-directionally with local network 908 via a communication channel 918. Local network 906 may communicate bi-directionally with global network 910 via a communication channel 920. Local network 908 may communicate bi-directionally with global network 910 via a communication channel 922. Global network 910 may communicate bi-directionally with server 912 and server 914 via a communication channel 924. Server 912 and server 914 may communicate bi-directionally with each other via communication channel 924. Furthermore, clients 902, 904, local networks 906, 908, global network 910 and servers 912, 914 may each communicate bi-directionally with each other.

In one embodiment, global network 910 may operate as the Internet. It will be understood by those skilled in the art that communication system 900 may take many different forms. Non-limiting examples of forms for communication system 900 include local area networks (LANs), wide area networks (WANs), wired telephone networks, wireless networks, or any other network suphousing apertureing data communication between respective entities.

Clients 902 and 904 may take many different forms. Non-limiting examples of clients 902 and 904 include personal computers, personal digital assistants (PDAs), cellular phones and smartphones.

Client 902 includes a CPU 926, a pointing device 928, a keyboard 930, a microphone 932, a printer 934, a memory 936, a mass memory storage 938, a GUI 940, a video camera 942, an input/output interface 944 and a network interface 946.

CPU 926, pointing device 928, keyboard 930, microphone 932, printer 934, memory 936, mass memory storage 938, GUI 940, video camera 942, input/output interface 944 and network interface 946 may communicate in a unidirectional manner or a bi-directional manner with each other via a communication channel 948. Communication channel 948 may be configured as a single communication channel or a multiplicity of communication channels.

CPU 926 may be comprised of a single processor or multiple processors. CPU 926 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 936 is used typically to transfer data and instructions to CPU 926 in a bi-directional manner. Memory 936, as discussed previously, may include any suitable computer-readable media, intended for data storage, such as those described above excluding any wired or wireless transmissions unless specifically noted. Mass memory storage 938 may also be coupled bi-directionally to CPU 926 and provides additional data storage capacity and may include any of the computer-readable media described above. Mass memory storage 938 may be used to store programs, data and the like and is typically a secondary storage medium such as a hard disk. It will be appreciated that the information retained within mass memory storage 938, may, in appropriate cases, be incorporated in standard fashion as part of memory 936 as virtual memory.

CPU 926 may be coupled to GUI 940. GUI 940 enables a user to view the operation of computer operating system and software. CPU 926 may be coupled to pointing device 928. Non-limiting examples of pointing device 928 include computer mouse, trackball and touchpad. Pointing device 928 enables a user with the capability to maneuver a computer cursor about the viewing area of GUI 940 and select areas or features in the viewing area of GUI 940. CPU 926 may be coupled to keyboard 930. Keyboard 930 enables a user with the capability to input alphanumeric textual information to CPU 926. CPU 926 may be coupled to microphone 932. Microphone 932 enables audio produced by a user to be recorded, processed and communicated by CPU 926. CPU 926 may be connected to printer 934. Printer 934 enables a user with the capability to print information to a sheet of paper. CPU 926 may be connected to video camera 942. Video camera 942 enables video produced or captured by user to be recorded, processed and communicated by CPU 926.

CPU 926 may also be coupled to input/output interface 944 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 926 optionally may be coupled to network interface 946 which enables communication with an external device such as a database or a computer or telecommunications or internet network using an external connection shown generally as communication channel 916, which may be implemented as a hardwired or wireless communications link using suitable conventional technologies. With such a connection, CPU 926 might receive information from the network, or might output information to a network in the course of performing the method steps described in the teachings of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be suphousing apertured by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to suphousing aperture a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the housing apertureions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which housing apertureions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a spinning device that automates controlled spinning of a composition according to the present invention will be apparent to those skilled in the art. Various aspects of the invention have been described above by way of illustration, and the specific embodiments disclosed are not intended to limit the invention to the particular forms disclosed. The particular implementation of the spinning device that automates controlled spinning of a composition may vary depending upon the particular context or application. By way of example, and not limitation, the spinning device that automates controlled spinning of a composition described in the foregoing were principally directed to a device that securely retains a bottle of insulin for automated spinning in a slow, uniform manner implementations; however, similar techniques may instead be applied to spinning of a variety of liquids that are susceptible to formation of air bubbles, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment. (Paragraph 110—the spacing changed)

What is claimed is:

1. A case comprising:
a housing, said housing comprising a top end, a bottom end, an outer surface, an inner surface, and at least one housing aperture;
a power source, said power source being configured to at least partially power said case;
at least one charging cable, said at least one charging cable being configured to transfer power to said power source through said at least one housing aperture;
at least one compartment, said at least one compartment being configured to enable storage in said housing;
a cover, said cover being configured to enable access to said at least one compartment, said cover comprising a wallet slot;
a payment card slot;
a universal payment card, said universal payment card being configured to move between a storage position being disposed at least partially inside said payment card slot, and an operational position being disposed at least partially outside of said payment card slot, wherein said operational position is configured to enable said universal payment card to perform a transaction;
a lever, said lever being configured to join said universal payment card with said housing, said lever further being configured to carry said universal payment card between said storage positon and said operational position;
an electromagnet, said electromagnet being configured to generate a magnetic field, said electromagnet further being configured to actuate said lever, wherein a signal interferes with said magnetic field to enable said lever to move said universal payment card to said operational position, wherein a code actuates said signal; and
a data transfer device, said data transfer device being configured to enable reception of a transaction data, said data transfer device further being configured to enable transfer of said transaction data to said universal payment card, wherein said universal payment card is configured to at least partially process said transaction data for performing said transaction.

2. The case of claim 1, wherein said housing is configured to receive a communication device.

3. The case of claim 2, wherein said housing comprises a flanged edge.

4. The case of claim 3, in which said housing comprises at least one member selected from said group consisting of: rubber, flexible polymer, high-density polyethylene, acrylonitrile butadiene styrene, polyvinyl chloride, polyethylene, stainless steel, aluminum, and aluminum alloy.

5. The case of claim 4, wherein said universal payment card is a credit card.

6. The case of claim 5, wherein said cover comprises a hinge end and a lock end.

7. The case of claim 6, wherein said lock end comprises an aperture, said aperture configured to mate with a clip on said housing.

8. The case of claim 7, further including a key, said key configured to lock and unlock said cover, said key further being configured to mate with a key axle in the housing.

9. The case of claim 8, wherein said electromagnet is a solenoid.

10. The case of claim 9, wherein said lever is a spring-loaded lever.

11. The case of claim 10, wherein said spring-loaded lever and said solenoid operatively connect.

12. The case of claim 11, wherein said code is a personal identification number.

13. The case of claim 12, wherein said signal is a Bluetooth signal.

14. The case of claim 13, wherein said data transfer device is a dongle.

15. The case of claim 14, further including a software application, said software application configured to download onto said communication device, said software application further configured to display as an icon on said communication device.

16. The case of claim 15, wherein said software application is configurable to receive said code and enable said communication device to generate said signal.

17. The case of claim 16, wherein said software is configured to lock and unlock said cover.

18. The case of claim 17, wherein said power source is a rechargeable battery.

19. A case comprising:
means for protecting communication means;
means for protecting specific transaction means and universal transaction means;
means for transferring transaction means from said specific transaction means to universal transaction means;
means for actuating a release means;
means for accessing said universal transaction means through said release means; and
means for performing said transaction means with said universal transaction means.

20. A case consisting of:
a housing, said housing comprising a top end, a bottom end, an outer surface, an inner surface, and at least one housing aperture;
a power source, said power source being configured to at least partially power said case, said power source comprising a rechargeable battery;
at least one charging cable, said at least one charging cable being configured to transfer power to said power source through said at least one housing aperture;
at least one compartment, said at least one compartment being configured to enable storage in said housing;
a cover, said cover being configured to enable access to said at least one compartment, said cover comprises a hinge end and a lock end, said cover further comprising a wallet slot, said wallet slot being configured to receive at least one item;
a key, said key being configured to engage a key axles in said housing for locking and unlocking said cover;
a payment card slot;
a universal payment card, said universal payment card comprising a credit card, said universal payment card being configured to move between a storage position being disposed at least partially inside said payment card slot, and an operational position being disposed at least partially outside of said payment card slot, wherein said operational position is configured to enable said universal payment card to perform a transaction;
a lever, said lever being configured to join said universal payment card with said housing, said lever further being configured to carry said universal payment card between said storage positon and said operational position;
an electromagnet, said electromagnet being configured to generate a magnetic field, said electromagnet further being configured to actuate said lever, wherein a signal interferes with said magnetic field to enable said lever to move said universal payment card to said operational position, wherein a code actuates said signal;
a data transfer device, said data transfer device being configured to enable reception of a transaction data, said data transfer device further being configured to enable transfer of said transaction data to said universal payment card, wherein said universal payment card is configured to at least partially process said transaction data for performing said transaction; and
a software application, said software application being configured to download onto said communication device, said software application further being configured to display as an icon on said communication device, said software application further being configured to lock and unlock said cover.
a housing, said housing comprising a top end, a bottom end, an outer surface, an inner surface, and at least one housing aperture, said at least one housing aperture configured to join with at least one charging cable;
at least one charging cable, said at least one charging cable configured to operatively join with said at least one housing aperture, said at least one charging cable comprising a USB cable;
at least one compartment, said at least one compartment being configured to enable storage in said housing;
a cover, said cover being configured to enable access to said at least one compartment, said cover comprising a slot;
a key, said key configured to lock and unlock said cover;
a universal payment card, said universal payment card being configured to move between a storage position at least partially inside said slot, and an operational position at least partially outside of said slot, wherein said operational position is configured to enable said universal payment card to perform a transaction;
a lever, said lever being configured to join said universal payment card with said housing, said lever further being configured to carry said universal payment card between said storage positon and said operational position, said lever comprising a spring-loaded lever;
an electromagnet, said electromagnet being configured to generate a magnetic field, said electromagnet further being configured to actuate said lever, wherein a signal interferes with said magnetic field to enable said lever to move said universal payment card to said operational position, said signal comprising a Bluetooth signal, wherein a code actuates said signal, said code comprising a personal identification number, said electromagnet comprising a solenoid;
a data transfer device, said data transfer device being configured to enable reception of a transaction data, said data transfer device further being configured to enable transfer of said transaction data to said universal payment card, wherein said universal payment card is configured to at least partially process said transaction data for performing said transaction, said data transfer device comprising a dongle; and
a power source, said power source being configured to substantially power said case, said power source comprising a rechargeable battery.
